(19) United States
(12) Patent Application Publication
(10) Pub. No.: US 2013/0177722 A1
(43) Pub. Date: Jul. 11, 2013

(54) Self-inflating buffer bag

(71) Applicant: Donghui Xu, Shanghai (CN)

(72) Inventor: Donghui Xu, Shanghai (CN)

(73) Assignee: Shanghai Zhijing Biological Technology Co., Ltd.

(21) Appl. No.: 13/431,938

(22) Filed: Mar. 27, 2012

(30) Foreign Application Priority Data
Jan. 11, 2012 (CN) 201220011032.8

(51) Int. Cl. B32B 1/06

(52) U.S. Cl. 428/35.5

(57) ABSTRACT

A self-inflating buffer bag includes a bag body having a periphery sealed; a separating plane for dividing the bag body into a plurality of inflators to seal each inflator with each other, wherein said separating plane includes a drape; wherein each inflator includes a first reactant storage chamber provided in the inflator, a second reactant storage chamber provided in the inflator, a first reactant provided in the first reactant storage chamber, a second reactant provided in the second reactant storage chamber for generating gas to inflate the inflator by a chemical reaction with the first reactant, and a trigger provided on the drape of the separating plane for breaking the first reactant storage chamber and the second reactant storage chamber to trigger a chemical reaction between the first reactant and the second reactant to generate gas under a pressure produced by an inflated neighboring inflator.

### BACKGROUND OF THE PRESENT INVENTION

1. Field of Invention

The present invention relates to a self-inflating buffer bag, and more particularly to a reusable self-inflating buffer bag which once triggers several inflators to generate gas.

2. Description of Related Arts

Compared with traditional large-sized buffer packages, such as the plastic foam and the corrugated paperboard, the inflatable buffer package is to be inflated when left unused, which suits to be stored and transported at a long distance and in a large scale. Meanwhile, the inflatable buffer package has a good buffering performance because the inflatable package is highly elastic. Besides, the inflatable package has a good barrier property and is able to resist water, oil and insect. Thus the inflatable buffering package is gradually gaining the popularity.

However, the inflatable package on market is usually pumped by the air pump. It is usually necessary to buy an air pump in order to use the inflatable package. This not only increases the cost, but also brings inconvenience, which limits the usage of the inflatable package to some extents.

Thus, an inflatable package provided with a gas source is invented. A Chinese patent, air cushion used for self-inflating capsule and self-inflating package and disposable foodstuff packaging box, with a patent number of 201183645, discloses a method that the air cushion for the package is designed to have an internal capsule and an external capsule, wherein the internal capsule is provided in a hollow cavity of the external capsule; the internal parts of the external capsule and the internal capsule are respectively filled with the matters which can trigger a chemical reaction and release gas by mutually contacting with each other; as long as the internal capsule is broken down or destroyed, a first matter and a second matter trigger the chemical reaction and release the gas which ruptures the external capsule and inflates the article to be inflated.

But the above technical solution still has the following disadvantages. Firstly, when the package bag is partially broken, the whole buffer bag would leak and fail to be normally used. Secondly, when the inflatable buffer bag is divided into several inflators, it is very tedious to trigger the gas generating reaction in each inflator one by one by hand. Thirdly, the reactants function in the large-sized inflating cavity so that it is not easy for the reactants to contact with each other. Fourthly, the solution after the chemical reaction is detained in the inflating cavity. Once the plastic air cushion or the rubber air cushion is accidentally punctured, the solution after the chemical reaction would leak. This makes the air cushion inappropriate for many objects which need strict protection from water, such as electronic products and food. Fifthly, since the packaging air cushion is disposable, recycling the waste brings pressure to the environment.

Thus the present invention makes the following improvements to completely or partially overcome the above disadvantages and defects of the conventional art.

### SUMMARY OF THE PRESENT INVENTION

An object of the present invention is to provide an inflatable buffer bag which is to be inflated and basically flat when left unused and also light in weight and small in size so as to save a storage room and suit for a transportation at a long distance and in a large scale; the inflatable buffer bag is inflated on the spot when being used.

Another object of the present invention is to provide a self-inflated buffer bag provided with a gas source which saves an inflating device when being used and brings convenience.

Another object of the present invention is to provide a self-inflating buffer bag which has several independent inflators and is still able to work normally when partially broken down.

Another object of the present invention is to provide a self-inflating buffer bag, several inflators of which are once triggered to generate gas.

Another object of the present invention is to provide a reusable self-inflating buffer bag.

Another object of the present invention is to provide a self-inflating buffer bag, a gas generating room and a gas cavity of which are separated with each other to contribute to a gas generating reaction.

Another object of the present invention is to provide a self-inflating buffer bag whose solution after a chemical reaction is prevented from leaking.

Another object of the present invention is to provide a group of gas generation agents which rapidly generate gas innoxious and not harmful to human body and also not combustion-supporting, not combustible and not explosive by contacting.

Another object of the present invention is to provide a group of gas generating agents whose products exclude steam.

A self-inflating buffer bag comprises:

a bag body having a periphery sealed;

a separating plane, formed by heat pressing or other cohering ways and separating the bag body into a plurality of inflators in such a manner that each inflator is separated with each other, wherein the separating plane comprises a drape;

wherein each of the inflators comprises:

a first reactant storage chamber, provided in an inner part of the inflator;

a second reactant storage chamber, provided in the inner part of the inflator;

a first reactant, provided in the first reactant storage chamber;

a second reactant, provided in the second reactant storage chamber and for a chemical reaction with the first reactant to generate gas to inflate the inflator; and

a trigger, provided on the drape of the separating plane and for rupturing the first reactant storage chamber and the second reactant storage chamber under an air pressure brought by an inflated neighboring inflator so that the first reactant and the second reactant trigger a chemical reaction to generate a gas.

The present invention has a beneficial result that one triggering is able to initiate an inflation of each inflator one by one.

These and other objectives, features, and advantages of the present invention will become apparent from the following detailed description, the accompanying drawings, and the appended claims.

### BRIEF DESCRIPTION OF THE DRAWINGS

FIG. 1 is a front elevation view of a self-inflating buffer bag according to a preferred embodiment of the present invention.

FIG. 2 is an enlarged view of a trigger and reactant storage chambers of the self-inflating buffer bag to be inflated according to the preferred embodiment of the present invention.

FIG. 3 is an enlarged view of a trigger and reactant storage chambers of the inflated self-inflating buffer bag according to the preferred embodiment of the present invention.

FIG. 4 is an enlarged view of a trigger and reactant storage chambers of the self-inflating buffer bag to be inflated according to another preferred embodiment of the present invention.

FIG. 5 is an enlarged view of a trigger and reactant storage chambers of the self-inflating buffer bag to be inflated according to another preferred embodiment of the present invention.

FIG. 6 is a front elevation view of a self-inflating buffer bag according to another preferred embodiment of the present invention.

FIG. 7 is a sketch view of a bag body of a self-inflating buffer bag according to another preferred embodiment of the present invention.

FIG. 8 is a sketch view of a gas generating device of the preferred embodiment of the present invention.

FIG. 9 is an enlarged view of a trigger and reactant storage chambers of the self-inflating buffer bag to be inflated according to an additional preferred embodiment of the present invention.

### DETAILED DESCRIPTION OF THE PREFERRED EMBODIMENT

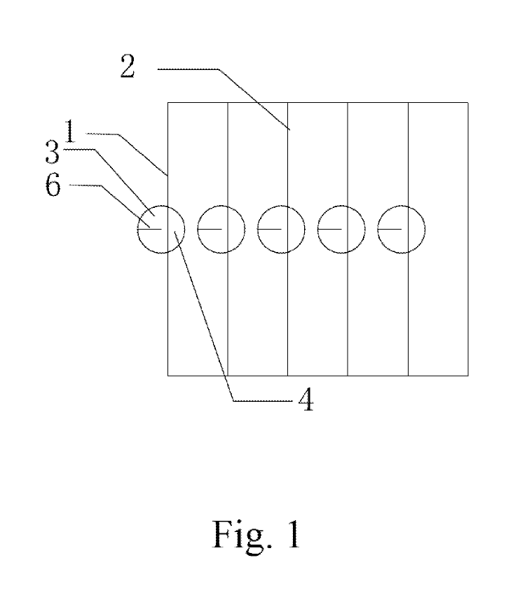

Referring to FIG. 1 of the drawings, according to a first preferred embodiment of the present invention, a self-inflating buffer bag having several inflators once triggered to generate gas comprises:

a bag body 1 having a periphery sealed;

a separating plane 2 for separating the bag body 1 into a plurality of inflators 12 in such a manner that each inflator 12 is sealed with each other, wherein the separating plane 2 comprises a drape 21;

wherein each inflator 12 comprises:

a first reactant storage chamber 3 provided in an inner part of the inflator 12;

a second reactant storage chamber 4 provided in the inner part of the inflator 12;

a first reactant 7 provided in an inner part of the first reactant storage chamber 3;

a second reactant 8, provided in an inner part of the second reactant storage chamber 4 and for generating gas by a chemical reaction with the first reactant 7 to inflate the inflator 12; and

a trigger 6, provided on the drape 21 of the separating plane and for rupturing the first reactant storage chamber 3 and the second reactant storage chamber 4 under a gas pressure after the neighboring inflator 12 has been inflated so as to allow a chemical reaction between the first reactant 1 and the second reactant 2 to generate gas.

With the above structure, the self-inflating buffer bag whose several inflators are once triggered to generate gas, usually in a state of being uninflated, is used by squeezing a marginal inflator 12 by hand to allow the trigger 6 in the inflator 12 to break the first reactant storage chamber 3 and the second reactant storage chamber 4 so that a chemical reaction between the first reactant 7 and the second reactant 8 is triggered to generate gas, in such a manner that the trigger 6 of a neighboring inflator 12 is pushed by the being inflated inflator 12 to move and thus another gas generating reaction is triggered in the neighboring inflator 12. In a same manner, under the gas pressure brought by the neighboring inflator 12, the trigger 6 orderly triggers the chemical reaction between the first reactant 7 and the second reactant 8 of each inflator 12 to generate the gas so as to finish an inflation of the whole self-inflating buffer bag. The self-inflating buffer bag is basically flat when left unused and also light in weight and small in size to suit for being stored and transported at a long distance and in a large scale; the self-inflating buffer bag is used by squeezing the marginal inflator 12 which accomplishes the inflation of the whole self-inflating buffer bag without complicated inflating devices. The self-inflating buffer bag has advantages of a simple structure, being easily used and so on.

The self-inflating buffer bag is preferably made of a plastic, a rubber, a compound material or other material which is soft, airproof, static-free, chemical corrosion resisting, strong enough, bending resisting, aging resisting and weather resisting. The self-inflating buffer bag is also preferred to be as thin as possible under satisfied qualifications of lifespan and strength and has a corresponding shape with an object to be packaged.

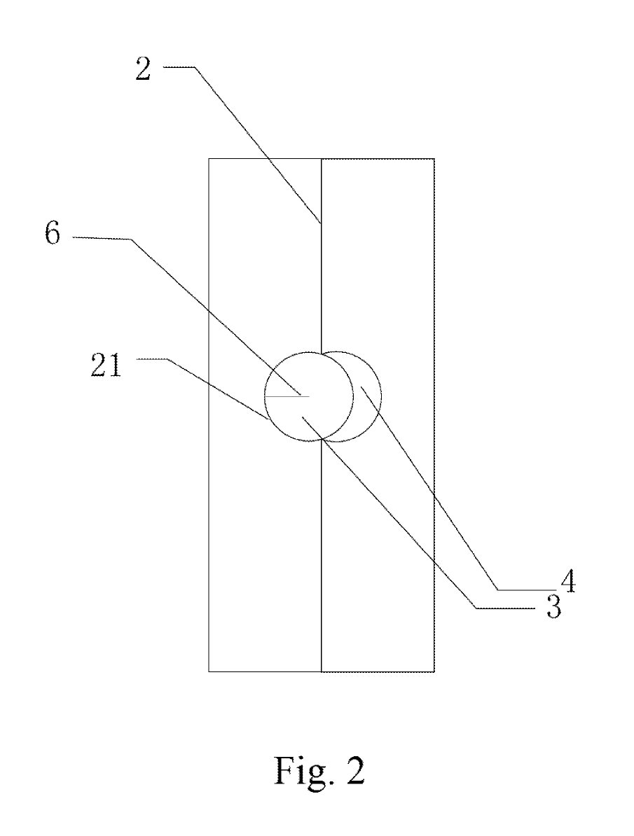

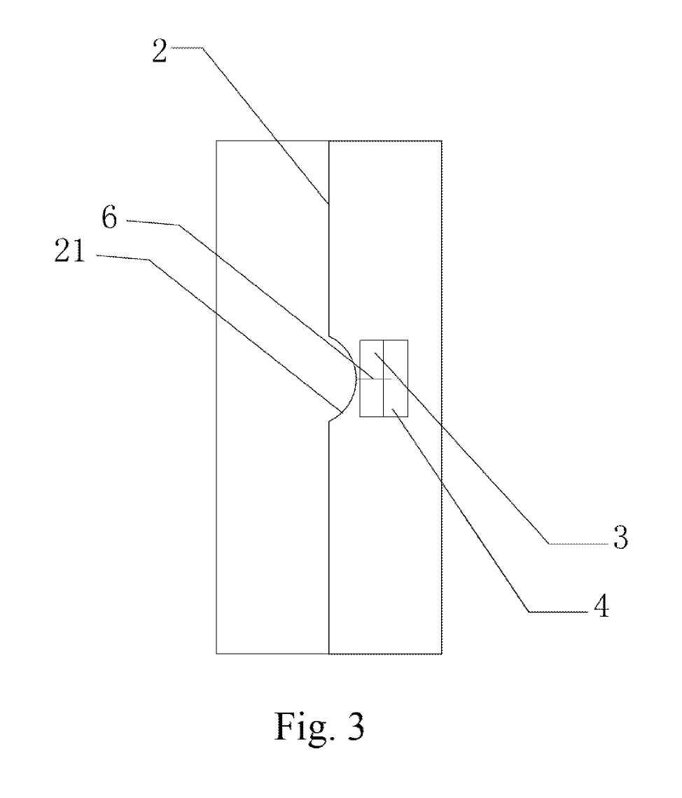

Referring to FIG. 2 and FIG. 3, according to a preferred embodiment of the present invention, the first reactant storage chamber 3 neighbors with the second reactant storage chamber 4 and an interlayer 16 is further provided between the first reactant storage chamber 3 and the second reactant storage chamber 4, wherein the first reactant storage chamber 3 is provided on the separating plane 2, so as to have a shared plane 15; the trigger 6 is provided on the shared plane 15 and in the inner part of the first reactant chamber 3; the interlayer 16 parallels with the separating plane 2 and is vertical with the needle-shaped trigger 6 for breaking the interlayer 16 and the second reactant storage chamber 4 by a removal of the needle-shaped trigger 6 under the pressure to trigger a gas generating reaction.

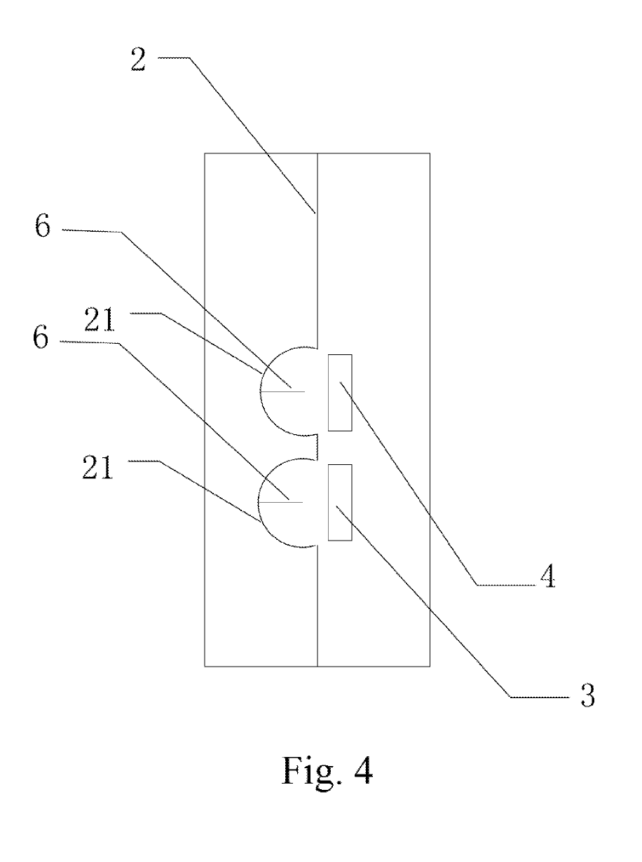

Referring to FIG. 4, according to a preferred embodiment of the present invention, the first reactant storage chamber 3 neighbors with the second reactant storage chamber 4 and an interlayer 16 is further provided between the first reactant storage 3 and the second reactant storage chamber 4, wherein the trigger 6 is provided on the drape 21 of the separating plane 2 and out of the first reactant storage chamber 3 and the second reactant storage chamber 4; the trigger 6 is pointed at the first reactant storage chamber 3 and the second reactant storage chamber 4 for breaking the first reactant storage chamber 3 and the interlayer 16 by producing a pressure to move the trigger 6 so as to trigger a gas generating reaction.

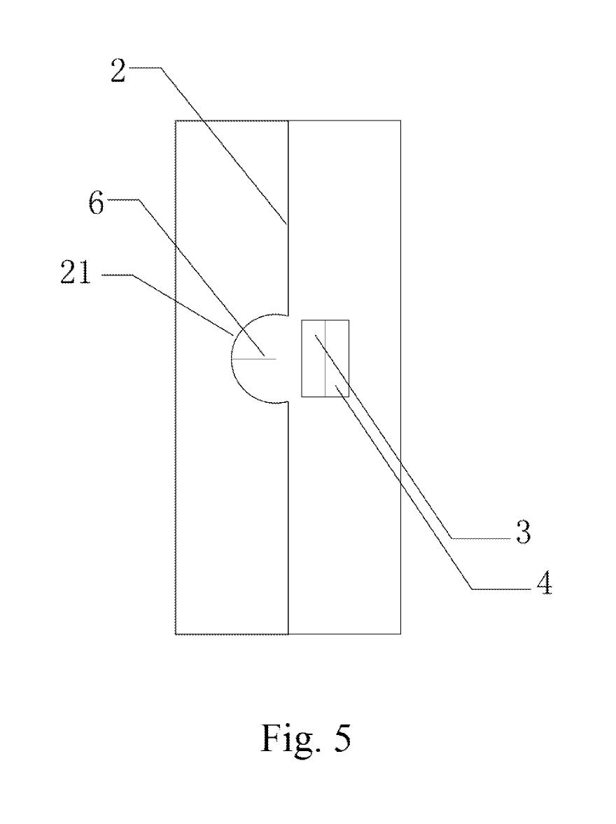

Referring to FIG. 5, according to a preferred embodiment of the present invention, the trigger 6 comprises two parts and the separating plane 2 comprises two drapes 21, wherein the two parts of the trigger 6 are respectively provided on the two drapes 21 of the separating plane 2 and respectively pointed at the first reactant storage chamber 3 and the second reactant storage chamber 4 for respectively breaking the first reactant storage chamber 3 and the second reactant storage chamber 4 by producing a pressure to move the two triggers 6 so as to trigger the gas generating reactions.

According to a preferred embodiment of the present invention, the bag body is made of a light plastic and the separating plane 2 is formed by heat pressing.

Further, the first reactant storage chamber 3 is made of the light plastic as the bag body does and formed by forming a drape or an indentation at each corresponding part of each inflator.

Further, the interlayer 16 and the second reactant storage chamber 4 both have dual-layer aluminum compound films consisting of a protective layer (OP), an external printing layer, an aluminum layer (AL) and a bonding agent (VC) and usually for packaging medicine, which can be easily pierced by needle-shaped objects and have good insulating performances.

Further, the trigger 6 is hard, plastic and needle-shaped to suit for being connected to the separating plane 2 by a common heat pressing, which is a simple art and has a low cost.

According to a preferred embodiment of the present invention, the first reactant 7 and the second reactant 8 respectively are sodium bicarbonate and a weakly acid solution such as acetic acid, citric acid and tartaric acid, which are common in daily lives, cheap, edible, safe and harmless to human bodies and able to react rapidly to generate carbon dioxide which is harmless and not toxic to human bodies, stable, not combustion-supporting, not combustible and not explosive.

Further, the sodium bicarbonate is preferred to be pressed into tablets to suit for being stored and the gas generating reaction.

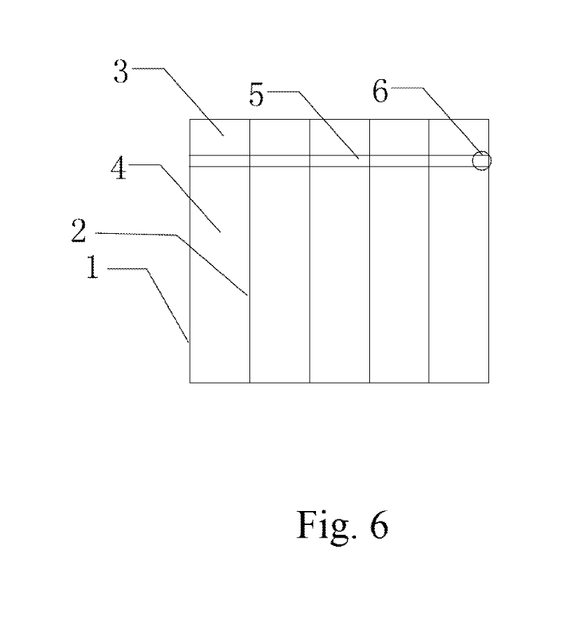

Referring to FIG. 6, according to a second preferred embodiment of the present invention, a self-inflating buffer bag whose several inflators are once triggered to generate gas comprises:

a bag body 1 having a periphery sealed;

a separating plane 2 for separating the bag body 1 into a plurality of inflators 12, wherein each inflator 12 is sealed with each other;

wherein each inflator 12 comprises:

a first reactant storage chamber 3 provided at a top end of the inflator 12;

a second reactant storage chamber 4 provided in an inner part of the inflator 12 and neighboring with the first reactant storage chamber 3;

a first reactant 7 provided in an inner part of the first reactant storage chamber 3; and

a second reactant 8 provided in an inner part of the second reactant storage chamber 4.

a sealed slot 5, provided out of the bag body and circling around the plurality of inflators 12 in a shape of a loop to separate the first reactant 7 with the second reactant 8, wherein there are at least one sealed slot 5;

a trigger 6 provided on the sealed slot 5 for separating the sealed slot 5, wherein a removal of the sealed slot 5 allows the first reactant 7 to contact with the second reactant 8 so as to once trigger gas generating reactions of all the inflators 12.

With the above structure, the self-inflating buffer bag, usually in a state of being uninflated, is used by pulling away the sealed slot 5 and turning the plurality of inflators 12 of the whole bag body 1 upside down to allow the first reactant 7 to contact with the second reactant 8 at the top end of the inflator 12, so that the chemical reaction between the first reactant 7 and the second reactant 8 occurs in all the inflators 12 to generate gas in the plurality of inflators 12 to finish the inflation. The self-inflating buffer bag is uninflated when left unused to suit for being stored and transported at a long distance and in a large scale; the self-inflating buffer bag is used by pulling away the zipper-typed trigger 6 so as to accomplish the inflation of the whole self-inflating buffer bag without complicated inflating devices. The self-inflating buffer bag whose several inflators are once triggered to generate gas has a simple structure and a low cost and is simply used.

The self-inflating buffer bag is preferably made of a plastic, a rubber, a compound material or other material which is soft, airproof, static-free, chemical corrosion resisting, strong enough, bending resisting, aging resisting and weather resisting. The self-inflating buffer bag is also preferred to be as thin as possible under satisfied qualifications of lifespan and strength and has a corresponding shape with an object to be packaged.

According to a preferred embodiment of the present invention, the bag body 1 has an end folded, wherein the folded part is pressed by the sealed slot 5 to be sealed so as to separate the first reactant 7 with the second reactant 8, which is a simple art and also easy and practical.

According to a preferred embodiment of the present invention, the first reactant 7 and the second reactant 8 respectively are sodium bicarbonate and a weakly acid solution (such as acetic acid, citric acid and tartaric acid), which are common, cheap, edible, safe and harmless to human bodies in daily lives and able to react rapidly to generate carbon dioxide which is harmless and not toxic to human bodies and also is stable, not combustion-supporting, not combustible and not explosive.

Further, the sodium bicarbonate is preferred to be pressed into tablets to suit for being stored and the gas generating reactions.

According to a preferred embodiment of the present invention, the sealed slot 5 is made of a plastic slightly thicker than the bag body 1, generated by a simple art and has a good insulation performance.

Further, the trigger 6 is made of a hard plastic or a light metal and has a good sealing performance to suit for triggering the gas generating reactions.

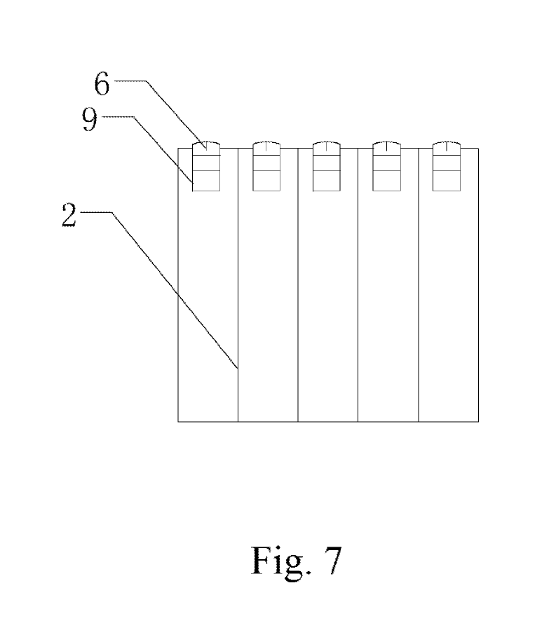

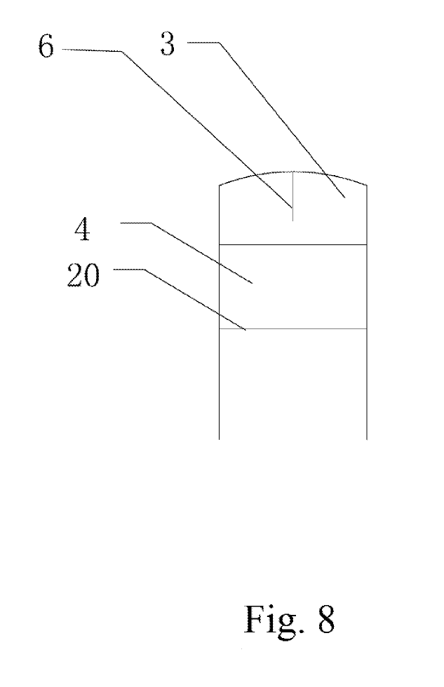

Referring to FIG. 7 and FIG. 8, according to a third preferred embodiment of the present invention, a reusable self-inflating buffer bag whose solution after a chemical reaction is prevented from leaking comprises:

a bag body 1;

a separating plane 2 for dividing the bag body 1 into a plurality of inflators 12 in such a manner that each inflator 12 is sealed with each other;

wherein each inflator 12 comprises:

an inflator mouth 9;

a gas generating device 10 detachably connected to the inflator mouth 9;

wherein the gas generating device 10 comprises:

a first reactant storage chamber 3;

a second reactant storage chamber 4;

an interlayer 5 provided between the first reactant storage chamber 3 and the second reactant storage chamber 4 and detachably connected to the gas generating device 10;

a first reactant 7 provided in an inner part of the first reactant storage chamber 3;

a second reactant 8, provided in an inner part of the second reactant storage chamber 4, for generating gas without water by a chemical reaction with the first reactant 7;

the trigger 6 for detaching the interlayer 5 from the gas generating device 10 to allow the first reactant 7 to contact with the second reactant 8 to trigger the gas generating reaction; and

a hydrophobic and breathable film 20 provided between the gas generating device 10 and the inflator mouth 9.

With the above structure, the self-inflating buffer bag, usually in a state of being uninflated, is used by squeezing the trigger 6 by hand to detach the interlayer 5 provided between the first reactant storage chamber 3 and the second reactant storage chamber 4 so as to allow the first reactant 7 to contact and react with the second reactant 8 to generate the gas which filtrates through the hydrophobic and breathable film 20 to inflate into the inflator 12, in such a manner that a self-inflation process is accomplished. Besides, since the gas generating device 10 and the inflator mouth 9 are detachable, the gas generating device 10 can be detached from the self-inflating buffer bag after using to suit for saving space for storage and transportation by releasing the gas. When the self-inflating buffer bag is used for a next time, the first reactant storage chamber 3, the second reactant storage chamber 4 and the interlayer 5 have not been broken, so the purpose of being reusable can be realized by adding the first reactant 7 and the second reactant 8 into the gas generating device 10. The self-inflating buffer bag relieves pressure on environment brought by recycling the used buffer bags and, at the same time, suits for some objects requiring transparent buffer packaging because the inflator 12 is inflated by the dry gas without the solution after the chemical reactions and especially for electronic produces and food requiring strict waterproofing since the gas generating device 10 retains the solution after the chemical reactions seldom with any leakage.

The self-inflating buffer bag is preferably made of a plastic, a rubber, a compound material or other material which is soft, airproof, static-free, chemical corrosion resisting, strong enough, bending resisting, aging resisting and weather resisting. The self-inflating buffer bag is also preferred to be as thin as possible under satisfied qualifications of lifespan and strength and has a corresponding shape with an object to be packaged.

According to a preferred embodiment of the present invention, the inflator mouth 9 and the gas generating device 10 further comprise screw threads by which the inflator mouth 9 and the gas generating device 10 are detachably connected with each other.

According to a preferred embodiment of the present invention, the first reactant 7 and the second reactant 8 are respectively sodium bicarbonate and a solution of aluminum sulfate, wherein the first reactant 7, the second reactant 8 and the gas generated are not poisonous or harmful to human bodies; the first reactant 7 and the second reactant 8 react rapidly and generate the dry gas without any water to inflate the inflator 12. The gas generating device 10 retains the solutions after the chemical reactions seldom with any leakage.

Further, the sodium bicarbonate is preferred to be pressed into tablets and the aluminum sulfate is preferred to be a solution so as to suit for storage and the gas generating reaction.

According to a preferred embodiment of the present invention, the hydrophobic and breathable film 20 is an expanded polytetrafluoroethylene (ePTFE) film which is strictly hydrophobic, chemical corrosion resisting including acid resisting and base resisting and well breathable. The hydrophobic and breathable film is able to work from −260° C. to 260° C. and even at an extreme environment.

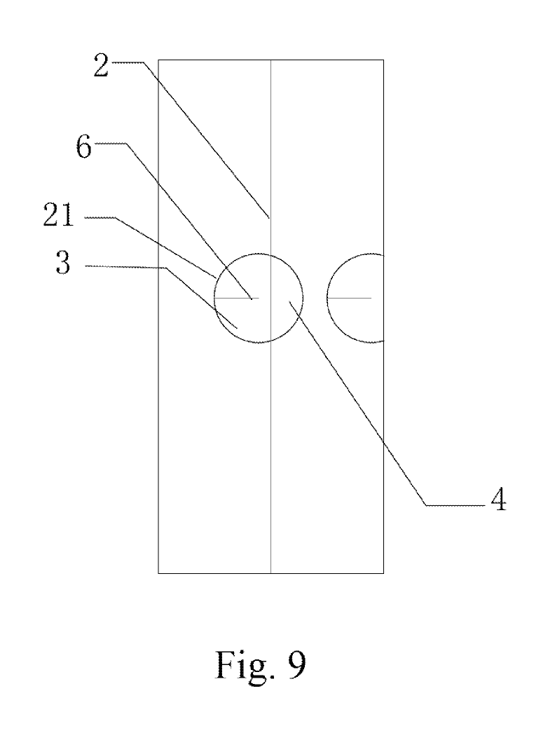

Referring to FIG. 9, according to a fourth preferred embodiment of the present invention, a self-inflating buffer bag whose several inflators are once triggered to generate gas comprises:

a bag body 1 having a periphery sealed;

a separating plane 2 for dividing the bag body 1 into a plurality of inflators 12 in such a manner that each inflator 12 is sealed with each other;

a first reactant storage chamber 3 provided at a side of each separating plane 2;

a second reactant storage chamber 4 provided at another side of each separating plane 2 and opposite to the first reactant storage chamber 3;

a first reactant 7 provided in an inner part of the first reactant storage chamber 3;

a second reactant 8 provided in an inner part of the second reactant storage chamber 4 for generating gas by a chemical reaction with the first reactant 7 to inflate the inflator 12; and

a trigger 6 provided in the inner part of the first reactant storage chamber 3, wherein the first reactant storage chamber 3 deforms under a gas pressure produced by the being inflated inflator 12 to allow the trigger 6 to break the separating plane 2 and the second storage chamber 4 so that a chemical reaction between the first reactant 7 and the second reactant 8 is triggered to generate the gas.

With the above structure, the self-inflating buffer bag whose several inflators are once triggered to generate gas, usually uninflated, is used by squeezing a marginal inflator 12 by hand to allow the trigger 6 in the inflator 12 to break the first reactant storage chamber 3 and the second reactant storage chamber 4 so that a chemical reaction between the first reactant 7 and the second reactant 8 is triggered to generate gas, in such a manner that the trigger 6 of a neighboring inflator 12 is pushed by the being inflated inflator 12 to move and thus another gas generating reaction is triggered in the neighboring inflator 12. In a same manner, under the gas pressure brought by the neighboring inflator 12, the trigger 6 orderly triggers the chemical reaction between the first reactant 7 and the second reactant 8 of each inflator 12 to generate the gas so as to finish an inflation of the whole self-inflating buffer bag. The self-inflating buffer bag is basically flat when left unused and also light in weight and small in size to suit for being stored and transported at a long distance and in a large scale; the self-inflating buffer bag is used by squeezing the marginal inflator 12 which accomplishes the inflation of the whole self-inflating buffer bag without complicated inflating devices. The self-inflating buffer bag has advantages of a simple structure, being easily used and so on.

Referring to FIG. 9, according to a preferred embodiment of the present invention, the first reactant storage chamber 3 and the second reactant storage chamber 4 can be respectively provided at different sides of the separating plane 2; the trigger 6, provided in the inner part of the first reactant storage chamber 3 and opposite to the separating plane 2 and the second reactant storage chamber 4, is for breaking the separating plane 2 and the second reactant storage chamber 4 at a side thereof to trigger a gas generating reaction by being pushed by a pressure produced by an inflated inflator 12.

In all the above preferred embodiments, gas can be generated by chemical methods or physical methods. For example, the inflator 12 has a gasbag of compressed air and gas can be generated by breaking the gasbag.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. A self-inflating buffer bag comprising:
a bag body having a periphery sealed;
a separating plane formed by heat pressing or other cohesion ways and for dividing said bag body into a plurality of inflators in such a manner that each said inflator is sealed with each other, wherein said separating plane comprises a drape structure;
wherein each said inflator comprises:
a first reactant storage chamber provided in said inflator;
a second reactant storage chamber provided in said inflator;
a first reactant provided in said first reactant storage chamber;
a second reactant provided in said second reactant storage chamber for generating gas by a chemical reaction with said first reactant to inflate said inflator; and
a trigger, provided on said drape of said separating plane, for breaking said first reactant storage chamber and said second reactant storage chamber to allow a chemical reaction between said first reactant and said second reactant to generate gas under a gas pressure produced by said inflated neighboring inflator.

2. The self-inflating buffer bag, as recited in claim 1, wherein said first reactant storage chamber neighbors with said second reactant storage chamber and an interlayer is further provided between said first reactant storage chamber and said second reactant storage chamber.

3. The self-inflating buffer bag, as recited in claim 2, wherein said first reactant storage chamber is provided on said separating plane and further comprises a shared plane with said separating plane; said trigger is provided on said shared plane and in said first reactant storage chamber and said interlayer is opposite to said separating plane and said trigger, in such a manner that said trigger is pushed by a pressure to move so as to break said interlayer and said second reactant storage chamber to further trigger a gas generating reaction.

4. The self-inflating buffer bag, as recited in claim 2, wherein said trigger is provided on said drape of said separating plane and out of said first reactant storage chamber and said second reactant storage chamber; said trigger, opposite to said first reactant storage chamber and said interlayer, is for breaking said first reactant storage chamber and said interlayer to trigger a gas generating reaction by being driven to move under a pressure.

5. The self-inflating buffer bag, as recited in claim 1, wherein said trigger comprises two parts and said separating plane comprises two said drapes;
said two parts of said trigger are respectively provided on said two drapes of said separating plane and respectively opposite to said first reactant storage chamber and said second reactant storage chamber, in such a manner that the two triggers are respectively able to break said first reactant storage chamber and said second reactant storage chamber to trigger gas generating reactions when being pushed to move under a pressure.

6. A self-inflating buffer bag comprising:
a bag body having a periphery sealed;
a separating plane for dividing said bag body into a plurality of inflators in such a manner that each said inflator is sealed with each other;
a first reactant storage chamber provided at a side of each said separating plane;
a second reactant storage chamber provided at another side of each said separating plane and opposite to said first reactant storage chamber;
a first reactant provided in said first reactant storage chamber;
a second reactant provided in said second reactant storage chamber for generating gas by a chemical reaction with said first reactant to inflate said inflator; and
a trigger, provided in said first reactant storage chamber, wherein, when said inflator is inflated, the first reactant storage chamber deforms under a gas pressure to allow said trigger to break said second reactant storage chamber which is opposite to said separating plane and said first reactant storage chamber, in such a manner that a chemical reaction between said first reactant and said second reactant is triggered to generate gas.

7. A self-inflating buffer bag comprising:
a bag body having a periphery sealed;
a separating plane for dividing said bag body into a plurality of inflators, wherein each said inflator is sealed with each other;
wherein each said inflator comprises: a first reactant storage chamber provided at an end of said inflator; a second reactant storage chamber provided in said inflator and neighboring with said first reactant storage chamber; said first reactant provided in said first reactant storage chamber; a second reactant provided in said second reactant storage chamber;
a sealed slot provided out of said bag body and circling around said plurality of inflators into a loop to separate said first reactant with said second reactant, wherein said sealed slot and said bag body are detachably connected;
a trigger provided on said sealed slot and able to move along said sealed slot, wherein, for using, said sealed slot is detached from said bag body by pulling away said trigger, in such a manner that gas generating reactions in all said inflators are once triggered by allowing said first reactant to contact with said second reactant.

8. The self-inflating buffer bag, as recited in claim 7, wherein said bag body has an end folded to form a folded part to separate said bag body into two parts which are respectively said first reactant storage chamber and said second reactant storage chamber; said folded part is pressed to be sealed by said sealed slot to separate said first reactant with said second reactant.

9-10. (canceled)
